(19) United States
(12) Patent Application Publication
(10) Pub. No.: US 2008/0044658 A1
(43) Pub. Date: Feb. 21, 2008

(54) METHOD OF MANUFACTURING A VEHICLE BODY PANEL PART, VEHICLE BODY PANEL PART, AND INTERMEDIATE PRODUCT IN MANUFACTURING A VEHICLE BODY PANEL PART

(76) Inventors: Matthias Ludwig, Vechelde (DE); Tobias Niesner, Gifhorn (DE)

Correspondence Address: CARLSON, GASKEY & OLDS, P.C., 400 WEST MAPLE ROAD, SUITE 350, BIRMINGHAM, MI, 48009, US

(21) Appl. No.: 11/839,568

(22) Filed: Aug. 16, 2007

(30) Foreign Application Priority Data
Aug. 21, 2006 (EP) 06 017 341.6

(51) Int. Cl. B32B 1/00

(52) U.S. Cl. 428/411.1; 156/242; 264/265; 427/244; 427/401

(57) ABSTRACT

A method of manufacturing a vehicle body panel part includes reshaping a transparent sheet that serves as an outer skin, where the transparent sheet has a front side and a rear side, and applying a panel onto some areas of the rear side of the transparent sheet. The panel is made of a transparent or translucent material and has a protective layer on its rear side. A wet application of a paint is provided onto the rear side of the transparent sheet to form a coloring layer. The transparent sheet is provided with a foamed backing on the rear side, at least in areas in which the transparent sheet is not covered by the panel, to form a foamed layer. The invention further relates to a vehicle body panel part and to an intermediate product obtained in manufacturing the vehicle body panel part.

### RELATED APPLICATIONS

The application claims priority to European Application No. 06 017 341.6, which was filed on Aug. 21, 2006.

### BACKGROUND OF THE INVENTION

The present invention relates to a method of manufacturing a vehicle body panel part and to such a vehicle body panel part. The invention further relates to an intermediate product obtained in manufacturing a vehicle body panel part.

Vehicle body panel parts are mounted to a vehicle body. They define at least sections of an outer skin of a vehicle in a final assembled condition and are visible from outside the vehicle. Vehicle body panel parts may be flaps (doors, covers, etc.), bumpers or roof modules, among other parts. There are vehicle body panel parts that include a glass-fiber reinforced polyurethane (PU) material. In one example, glass fibers are injected into a plastic material in a so-called long fiber injection (LFI) method. In this process, a deep-drawn, solid-colored sheet made of a plastic material or aluminum is placed into a foaming mold, and is provided with a foamed backing. The solid-colored sheet is substituted for an external paintwork to constitute the outer skin of the vehicle.

What is important in manufacturing vehicle body panel parts is that the color of the vehicle body panel part does not differ in color from an adjacent, painted vehicle body, so that a continuous common colored surface is produced. However, when the solid-colored sheet known from the prior art is reshaped, especially in the case of metallic colors, shades or tints may appear at corners and edges of the solid-colored sheet, which interrupts the even colored surface. Another drawback is that a sufficiently large amount of appropriately solid-colored sheets would need to be prefabricated for each type of color.

EP 1 669 277 discloses gluing transparent or translucent components to an adjacent frame part in order to integrate the transparent or translucent portions into body panel parts to form panoramic roofs. The drawback with vehicle body panel parts made this way is that a gap between the components requires the use of seals, which are subject to wear and are detrimental to the visual appearance.

It is the object of the present invention to provide a vehicle body panel part that has a continuous outer surface without an offset in height. It is a further object of the invention to provide a method of manufacturing a vehicle body panel part by which such a the vehicle body panel part may be manufactured cost-effectively and in a simple manner. Yet another object of the invention is to provide an intermediate product in the manufacture of such a vehicle body panel part.

### SUMMARY OF THE INVENTION

The objective of the invention is achieved by providing a method for manufacturing a vehicle body panel part, which is described as including the following steps described below. A transparent sheet serving as an outer skin, and having a front side and a rear side, is reshaped. A panel is applied onto some areas of the rear side of the transparent sheet. The panel is made of a transparent or translucent material and has a protective layer on a rear side. A wet application of a paint is applied onto the rear side of the transparent sheet to form a coloring layer. The transparent sheet is provided with a foamed backing on the rear side, at least in areas in which the transparent sheet is not covered by the panel, to form a foamed layer.

In one example, the outer skin is reshaped, and comprises a transparent colorless sheet with a thickness in a range of 0.5 to 2 mm. An inherently stiff panel made of a transparent or translucent material is then applied onto the rear side of the transparent sheet. The panel is provided with a protective layer. This is followed by a wet application of a paint onto the rear side of the transparent colorless sheet to form a coloring layer, i.e. the coloring layer is not a sheet that is attached with glue. The paint is dried after application and forms the coloring layer for an outer face of the vehicle body panel part, which is no longer painted on the outside. The transparent colorless sheet is subsequently provided with a foamed backing on the rear side, at least in those areas in which the transparent colorless sheet is not covered by the panel. In one example, all of the areas not covered by the panel are provided with a foamed backing. In those areas where the panel is provided, the protective layer provided on a rear side of the panel protects the panel from any “contaminations” which may be caused during wet application of the paint, such as by an atomized spray, or during application of the PU material. After the wet application of the paint, or after provision of the foamed backing, the protective layer can simply be removed along with the contaminations (paint, PU material, etc.). Unlike in the prior art, the transparent colorless sheet serving as the outer skin is not solid-colored itself, but the separate coloring layer shines, i.e. is visible, through the transparent colorless sheet to give the vehicle body panel part its color in those areas in which color is provided. The color of the vehicle body panel part corresponds to that of the rest of the vehicle body. In this way, a vehicle body panel part may be produced which has a transparent or translucent area and a stable foamed layer, and which features a continuous outer surface without any gaps between different areas. Further, the paint extends exactly as far as to the panel without any gap.

In addition, the panel may be configured in an edge region such that the panel has geometries that allow an interlocking fit between a foamed layer of the foamed backing and the panel, such as lateral edges that run conically to the rear side, grooves, undercuts, cross-pieces or the like.

The invention further relates to a body panel part for a vehicle, in particular a roof module. The body panel part includes a transparent sheet, which fully constitutes the outer skin of the vehicle body panel part, and a panel that is attached to part of the transparent sheet on the rear side, and which is made of a transparent or translucent material. A foamed layer is provided on the rear side of the transparent sheet in areas not covered by the panel. A coloring layer is provided between the foamed layer and the transparent sheet. With respect to the advantages, reference is made to the discussion above.

According to one embodiment, the panel is an inherently stiff sheet. The panel has a higher resistance to bending than the transparent sheet serving as the outer skin, which attains the required stiffness of the vehicle body panel part.

According to a further embodiment, the panel is made of glass.

The invention further relates to an intermediate product obtained in the manufacture of a vehicle body panel part. The intermediate product includes a transparent sheet and a panel that is attached to the rear side of the transparent sheet to partially cover the transparent sheet. The panel is made of a transparent or translucent material. A foamed layer is produced by providing the transparent sheet with a foamed backing in areas not covered by the panel. A coloring layer is provided between the foamed layer and the transparent sheet, and a removable protective layer is applied on the rear side of the panel.

These and other features of the present invention can be best understood from the following specification and drawings, the following of which is a brief description.

### BRIEF DESCRIPTION OF THE DRAWINGS

FIG. 1 shows a perspective view of a vehicle with a vehicle body panel part according to the invention in the form of a roof module.

FIG. 2 shows a basic structure of the vehicle body panel part according to the invention in one method step.

FIG. 3 shows an intermediate product according to the invention in another method step.

FIG. 4 shows the finished body panel part in another method step.

### DETAILED DESCRIPTION OF THE PREFERRED EMBODIMENT

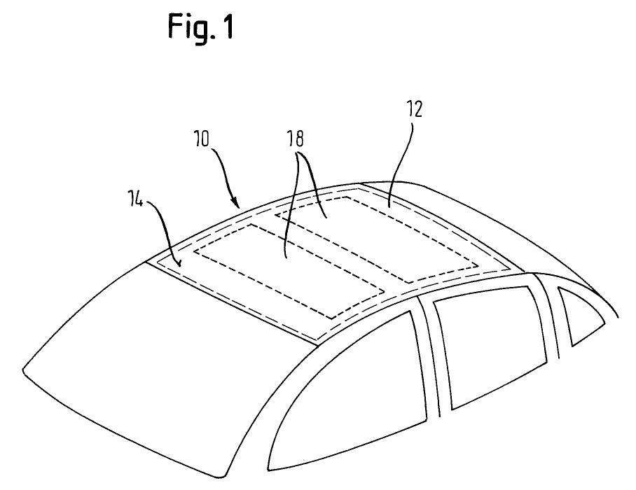

FIG. 1 shows a vehicle body panel part 10 in the form of a roof module in a condition mounted to a vehicle. The vehicle body panel part 10 could also be a fender, a door, or a flap (engine hood, trunk lid, etc.) of a vehicle.

The basic structure of the vehicle body panel part 10 is shown in FIG. 4.

The vehicle body panel part 10 has an outer skin that is visible from outside of the vehicle in a condition mounted to the vehicle. The outer skin is formed by a thin, transparent, thermally reshaped sheet 12. The sheet 12 is made of a transparent or translucent plastic material and has a front side 14, which in the installed condition is visible from the outside, and a rear side 16. Some areas on the rear side 16 of the sheet 12 are provided with at least one transparent or translucent panel 18 (two are shown) that is an inherently stiff sheet, or is made of glass. The panel 18 is, e.g., glued onto the sheet 12.

In those areas in which no panel 18 is applied on the rear side 16 of the sheet 12, the sheet 12 is provided with a foamed backing on the rear side 16. A foamed layer 20 produced in the process comprises a glass-fiber reinforced PU foam. Glass fibers F are introduced in the PU foam by using the LFI method, which reinforces the foamed layer 20. The foamed layer 20 has a higher resistance to bending than the sheet 12 serving as the outer skin, and constitutes a kind of support frame.

Provided between the sheet 12 and the foamed layer 20 is a coloring layer 22 which is in the form of a coat of paint, for example. The coloring layer 22 takes on the function of the exterior paintwork since the coloring layer 22 shines through, i.e. is visible through, the colorless and transparent sheet 12 and can be viewed from outside the vehicle.

In the method of manufacturing the vehicle body panel part 10, the sheet 12 is reshaped by being deep-drawn or thermoplastically reshaped.

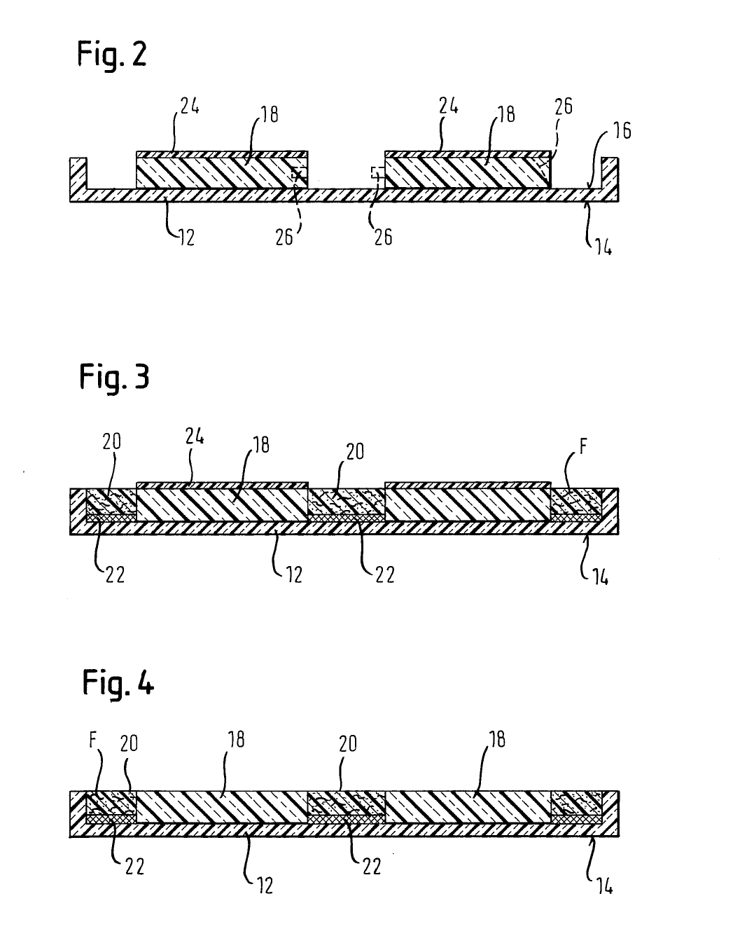

Subsequently, the panel 18 is glued onto the rear side 16 of the sheet 12. The panel 18 is provided on its rear side with a protective layer 24, in particular a strip-off film (FIG. 2).

A paint is applied wet on the rear side 16 of the sheet 12. In one example, paint is applied onto the entire component (i.e. onto the sheet 12 and the protective layer 24). The wet application can be performed by knife coating, rolling, or using a spray-painting method. When the paint, which is applied wet, has dried, the coloring layer 22 has been formed.

With a foaming mold open (not shown), a liquid PU material is applied onto the rear side of the sheet 12, at least in those areas of the sheet 12 which are not covered by the panel 18, and is accompanied by the injection of glass fibers F (LFI method).

A two-part foaming mold is transferred to a closed condition and the PU material expands and fills a cavity formed between lower and upper mold parts (not shown) to constitute the foamed layer 20 after the foaming process. When the lower and upper mold parts have been separated, an intermediate product (FIG. 3) is removed from the foaming mold (not shown). A rear side of the intermediate product features the protective layer 24 which protects the panel 18 from any contaminations (paint, PU material, etc.). A marginal region of the panel 18 has geometries 26 (undercuts, grooves, chamfers, cross-pieces, etc., see dashed lines in FIG. 2) that allow an interlocking fit between the panel 18 and the foamed layer 20.

The protective layer 24 is then removed from the panel 18 so that any contaminations, which may have been produced in applying the paint or the PU material, are removed from the rear side of the panel 18. In the area of the panel 18, the vehicle body panel part 10 remains transparent or translucent, and in the area in which the coloring layer 22 is provided, this coloring layer 20 shines through the sheet 12, as a result of which any exterior paintwork of the vehicle body panel part 10 is eliminated. The coloring layer 22 shining through the sheet 12 does not differ from the color of the rest of the vehicle body.

The method described above may be put to use to manufacture a vehicle body panel part having a continuous outer surface, in particular a panoramic roof, simply and at reasonable cost. This means that there are no gaps between the vehicle body panel parts made up of a plurality of parts, which previously required complicated sealing. The panel 18 and the foamed layer 20 have a higher resistance to bending than the sheet 12, so that a sturdy vehicle body panel part 10 is formed and the required stiffness is achieved.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of manufacturing a vehicle body panel part comprising:
(a) reshaping a transparent sheet serving as an outer skin, the transparent sheet having a front side and a rear side;
(b) applying a panel onto at least some areas of the rear side of the transparent sheet, the panel being made of one of a transparent and a translucent material and having a protective layer on a rear side of the panel;
(c) providing a wet application of a paint onto the rear side of the transparent sheet to form a coloring layer; and
(d) providing the transparent sheet with a foamed backing on the rear side, at least in areas in which the transparent sheet is not covered by the panel, to form a foamed layer.

2. The method according to claim 1, including applying the foamed layer onto the coloring layer after the paint has dried.

3. The method according to claim 1, including removing the protective layer from the panel after providing at least one of the paint and foamed layer.

4. The method according to claim 1, wherein the protective layer is a film.

5. The method according to claim 1, including gluing the panel onto the rear side of the transparent sheet.

6. A vehicle body panel part comprising:
a transparent sheet that fully constitutes an outer skin of the vehicle body panel part, the transparent sheet having a front side and a rear side;
a panel attached to part of the transparent sheet on the rear side, the panel comprising one of a transparent and translucent material;
a foamed layer provided on the rear side of the transparent sheet in areas not covered by the panel; and
a coloring layer provided between the foamed layer and the transparent sheet.

7. The vehicle body panel part according to claim 6, wherein the panel has a greater stiffness than a stiffness of the transparent sheet.

8. The vehicle body panel part according to claim 6, wherein the panel is made of glass.

9. The vehicle body panel part according to claim 6, wherein the vehicle body panel part comprises a roof module.

10. An intermediate product obtained in a manufacture of a vehicle body panel part comprising:
a transparent sheet;
a panel attached to a rear side of the transparent sheet and which partially covers the transparent sheet, the panel being made of one of a transparent and a translucent material;
a foamed layer produced by providing the transparent sheet with a foamed backing in areas not covered by the panel;
a coloring layer provided between the foamed layer and the transparent sheet; and
a removable protective layer applied on a rear side of the panel.
